(19) United States
(12) Patent Application Publication
(10) Pub. No.: US 2001/0053745 A1
(43) Pub. Date: Dec. 20, 2001

(54) CATALYTIC CONVERTER HAVING CATALYST WITTH NOBLE METAL ON ALUMINA AND MOLECULAR SIEVE CRYSTAL SURFACE AND METHODS OF MAKING SAME

(76) Inventors: KARL C. KHARAS, TULSA, OK (US); HEINZ J. ROBOTA, TULSA, OK (US)

Correspondence Address: KENNETH E. KUFFNER, KUFFNER & ASSOCIATES, P O BOX 25914534, HOUSTON, TX, 77265

(21) Appl. No.: 09/250,578

(22) Filed: Feb. 16, 1999

(51) Int. Cl. B01J 29/00; B01D 53/34; B01J 21/04; B01J 23/38

(52) U.S. Cl. 502/332; 502/66; 502/74; 502/355; 422/168

(57) ABSTRACT

A catalytic converter for treating exhaust gas from an internal combustion engine containing a catalyst characterized by having platinum or a platinum alloy dispersed on alumina particles and predominantly on the exterior surface of molecular sieve crystals. Also provided is a catalyst for such a converter and processes for manufacture of such catalyst. In addition, methods for treating exhaust gas from an internal combustion engine to reduce the amounts of hydrocarbon, carbon monoxide and nitrogen oxides emitted to the atmosphere are included.

This application is a continuation-in-part of application Ser. No. 09/012,095, filed Jan. 22, 1998, pending, which is a continuation-in-part of application Ser. No. 08/788,214, filed Jan. 27, 1997, pending.

### FIELD OF THE INVENTION

This invention relates to a catalytic converter containing therein a catalyst having noble metal dispersed on alumina and on the surface of molecular sieve crystals. This invention further relates to a catalyst suitable for such converter, a process for treating the exhaust gas from an internal combustion engine, and processes for making a catalyst having noble metal dispersed on alumina and on the exterior surface of molecular sieve crystals.

### BACKGROUND OF THE INVENTION

Catalytic converters containing various catalysts have been employed for years by automobile manufacturers to meet the ever-more-stringent regulations on emissions of hydrocarbon, carbon monoxide, and particularly, nitrogen oxides from internal combustion engines. Concurrently with the promulgation of these ever-tightening regulations on emissions, automotive engine manufacturers have worked to improve the fuel economy of such engines. This effort has led to the development of engines that operate with an excess of air beyond that which is required to consume stoichiometrically the fuel admitted to such engines (“lean-burn engines”). The advent of lean-burn engines has, in turn, exacerbated the problem of reducing emission of nitrogen oxides from internal combustion engines.

Various techniques have been developed to treat exhaust gas from internal combustion engines. One approach has been to provide multiple catalyst chambers in the exhaust system filled with different catalysts suited to particular tasks, such as that taught by Takeshima, et al. in U.S. Pat. No. 5,233,830.

Another approach is to provide a control system operating in conjunction with a catalytic converter, such as taught by Hirota, etal. in U.S. Pat. Nos. 5,201,802 and 5,189,876, and also by Takeshima in U.S. Pat. No. 5,029,061.

Clearly, there is a need for a simple system capable of treating exhaust gas from internal combustion engines, particularly the exhaust gas from lean-burn engines. The present invention is such a system, employing as it does a single catalytic converter having a single, unique catalyst contained therein which is capable of reducing the amount of hydrocarbon, carbon monoxide and, particularly, nitrogen oxides contained in exhaust gas prior to such gas's discharge to the atmosphere.

As stated above, the key element in such a system is the discovery of a catalyst which is effective in oxidizing hydrocarbon and carbon monoxide while being surprisingly effective at concurrently reducing nitrogen oxides in the environment presented by exhaust gas from internal combustion engines. Numerous inventions in this area have been taught by others skilled in the art, but none of these resembles more than superficially the catalyst of the present invention. For instance, U.S. Pat. No. 5,376,610 (Takahata, et al.) teaches, as part of a multi-catalyst system for exhaust gas purification, a catalyst consisting of alumina, and optionally zeolite, with Pt and/or Pd impregnated therein.

U.S. Pat. No. 5,292,991 (Lachman, et al.) teaches a catalyst consisting of a mixture of alumina and zeolite on a substrate with noble metal predominately dispersed on the alumina.

The teachings of U.S. Pat. No. 4,082,699 (Petrow, et al.) superficially resemble the present invention. Petrow, et al. teach a catalyst comprising pellets of alumina impregnated with platinum and assert that the platinum is deposited close to the pellet's surface, with alumina particles inside the pellet having no platinum. This teaching is, however, very different from that of the present invention wherein noble metal is deposited on virtually all alumina particles and on the external surfaces of the molecular sieve particles.

Patents have also been granted for catalysts intended for other uses, and some of these also closely resemble, at least superficially, the catalyst of the present invention. U.S. Pat. No. 5,314,854 (Galperin) teaches a catalyst designed primarily for the dehydrocyclization of paraffins to aromatics that consists of large pore molecular sieves mixed with binder and formed into pellets, spheres, or other such particles, said particles then having a surface-layer palladium component and uniformly dispersed platinum.

U.S. Pat. No. 4,992,158 (Schweizer) teaches a catalyst for reforming hydrocarbons having boiling points in the range of motor gasoline that is characterized as L-type zeolite not fully impregnated with Pt or Pd, using Pt- or Pd- acetylacetonate as the noble metal compound to treat the L-zeolite.

U.S. Pat. No. 5,017,541 (Schmidt, et al.) teaches a catalyst for the isomerization of alkanes consisting of particles of refractory inorganic oxide having a slightly higher concentration of a metal from the platinum group at the surface of such particles than at their center. The width of the surface-enriched band is 100-150 μm while the particles themselves have diameters of about 0.7-3.3 μm.

Still more patents have been granted for the preparation of noble metal/zeolite catalysts without regard to the use of same. U.S. Pat. No. 4,556,646 (Bezman) teaches a method for the preparation of a catalyst consisting of an inorganic oxide, a zeolite, and a noble metal in which ammonium nitrate is employed as an impregnating agent for Pd to produce a uniform distribution of the metal throughout the catalyst particles. Data are presented showing that, if ammonium nitrate is not used, Pd is concentrated in the outer shell of the catalyst particles. In this case, however, the Pd is deposited on the inorganic oxide as well as the zeolite, and the inventor suggests that deposition of Pd in the outer shell is a condition to be avoided.

U.S. Pat. No. 4,882,307 (Tsao) teaches the use of various salts, including sulfites, of cationic Pt complexes as an agent for the deposition of Pt into zeolite as a way of yielding highly dispersed Pt crystallites, after appropriate treatments.

U.S. Pat. No. 4,683,214 (Angevine, et al.) also teaches the use of sulfite salts of cationic noble metal complexes as a means of depositing noble metal on zeolite to yield, after appropriate treatment, very highly dispersed metal crystallites.

And, finally, U.S. Pat. No. 5,290,534 (Tsao) teaches that when a noble metal precursor is placed into a reactor during the production or synthesis of ZSM-18 substantially all of the noble metal remains on the outside of the synthesized ZSM-18. No indication is given that this is a desirable result, however, since the point of this invention is to provide a method of removing organic material blocking the pores of a zeolite.

### SUMMARY OF THE INVENTION

It is a feature of the invention to provide superior catalytic converters for removing NOₓ from the exhaust of internal combustion engines that are operating with the air-to-fuel ratio in the lean range, that is, where the amount of oxygen supplied is greater than the stoichiometric amount needed to support combustion.

This invention provides for a catalytic converter suitable for treating exhaust gas from an internal combustion engine, and particularly for treating the gas from a lean-bum motor vehicle engine. The catalytic converter of the present invention comprises an exhaust gas processing vessel of suitable size and shape that is adapted to receive exhaust directly from the engine. Contained in this vessel is an effective amount of a catalyst coating uniformly dispersed on a suitable substrate. The substrate, in turn, is adapted to fit within the vessel in such a way as to assure that the exhaust gas adequately and effectively contacts the catalyst coating on the substrate.

The catalyst coating for use in this invention is characterized as comprising molecular sieve crystals on the surface of which has been uniformly dispersed a catalytically effective amount of a noble metal, preferably platinum or a platinum alloy and alumina impregnated with a catalytically effective amount of a noble metal, preferably platinum or a platinum alloy. The molecular sieve crystals on which the noble metal has been dispersed have diameters within a range of about 0.5 to about 50 μm. The portion of the noble metal that is dispersed on the surface of the molecular sieve crystals is done so in such a manner as to locate at least 90% of the noble metal within 50 nm (500 Å) of the exterior surface of the crystals. The alumina particles upon which the remainder of the noble metal is dispersed are also small, preferably about 5 μm in size.

A wide range in the relative amounts of molecular sieve and alumina, and in the proportion of noble metal dispersed on each, is permitted in the catalyst coating for use in this invention. The finished coating may contain amounts of molecular sieve and alumina such that the weight ratio of molecular sieve to alumina is between about 0.1 and about 10, with the preferred ratio being between about 1 and about 3. The molecular sieve in the finished coating may contain from about 10 wt. % to about 90 wt. % of the total amount of noble metal dispersed in the finished coating, preferably from about 20 wt. % to about 60 wt. %, with the balance of the noble metal dispersed on the alumina contained in the coating.

This invention also provides a catalyst for such a catalytic converter and processes for making such catalyst. In one process for making the catalyst according to this invention such that part of the noble metal is dispersed predominately on the exterior surface of the molecular sieve crystals and the remainder of the noble metal is dispersed on the alumina particles, the first step is to prepare two aqueous suspensions, one such suspension comprising molecular sieve crystals and a noble metal reagent that will chemisorb onto the exterior 50 nm (500 Å) of the said crystals and the other aqueous suspension comprising alumina particles previously milled to a suitable size and a noble metal reagent.

The noble metal reagent mixed with the alumina particles in aqueous suspension need not be the same reagent as that used in admixture with the molecular sieve, but since using the same reagent is usually more convenient, such is preferred. Prior to preparing the suspension, the alumina should be milled until its mean particle diameter is reduced to the desired size. An aqueous suspension comprising the milled alumina, without the normal addition of acid that partially peptizes the alumina, and the desired amount of noble metal reagent is then formed and stirred for sufficient time to disperse the reagent evenly on the alumina particles, usually about two hours. This alumina suspension is then later combined with an aqueous suspension comprising molecular sieve crystals and a noble metal reagent that will chemisorb onto the exterior 50 nm (500 Å), coated onto a suitable substrate, dried and calcined at a temperature sufficient to decompose the base reagent material.

Depending on the noble metal reagent used, bonding of the reagent to the sieve will be either covalent or ionic. If the reagent chosen forms a covalent bond, it is important that the molecular sieve crystals used in this process be modified to have a very thin film of aluminum oxide on their exterior surfaces. The choice of method for forming this thin alumina film depends on the Si/Al ratio of the zeolitic precursor. Sufficient acid or base may be added to the suspension to adjust the pH to between about 7-8. Any pH adjustment should be done using a material that will decompose to yield gaseous products when its temperature is raised above about 150° C. If the reagent chosen forms an ionic bond to the sieve, no modification to the zeolite to form a thin alumina film is necessary, but the pH of the aqueous suspension of molecular sieve crystals and noble metal reagent should be above 10 and the chosen reagent must be a cationic noble-metal complex whose kinetic radius of its smallest conformation is larger than the largest crystallographically-defined pore of the zeolite chosen. Appropriate noble metal reagents of the type that form a covalent bond that, when suspended in water, will chemisorb onto the exterior 50 nm (500 Å) of said crystals include Pt sulfite and [N(C₂H₅)₄]₂ [pt(OH)₆]. Appropriate noble metal reagents of the type that form anionic bond that, when suspended in water, will chemisorb onto the exterior 50 nm (500 Å) of said crystals, include [Pt(NH₂CH₂CH₂NH₂)₂][OH]₂ and [Pt(NH₂CH₂CH₂NH₂)₂][CO₃]. After mixing the reagent with the molecular sieve the suspension is stirred for sufficient time to disperse the reagent evenly on the molecular sieve surface, usually about two hours.

Alternatively, an aqueous suspension of molecular sieve crystals of at least one type having noble metal dispersed predominantly on the exterior surface of the crystals can be made by a process in which the first step is to prepare an aqueous suspension of the crystals with a hydrophilic polymer having a density between about 0.8 gm/cm³ and about 1.0 gm/cm³, the amount of polymer used being sufficient to fill the pores of the molecular sieve crystals used. Thereafter a suitable noble metal reagent (which need not be chemisorbing) is added to the suspension and the pH is adjusted to between about 7 and 8. To form the finished coating of this invention, the molecular sieve suspension is combined with the alumina suspension as above, then coated on a suitable substrate, dried and calcined. In the process of heating, the material used to adjust the pH and the hydrophilic polymer are completely burned off and vaporized, thereby leaving the noble metal dispersed uniformly on the first 50 nm (500 Å) of the molecular sieve crystals.

A third method for making an aqueous suspension containing molecular sieve crystals of at least one type having noble metal dispersed predominantly on the exterior surface of the crystals employs the use of colloidal particles of platinum or a platinum alloy of a size substantially greater, by at least a factor of two, than the largest crystallographically defined pore diameter of the molecular sieve crystals onto which the noble metal is to be deposited.

Finally, this invention provides processes for treating exhaust gas from an internal combustion engine using the catalytic converter and catalyst of the present invention.

### BRIEF DESCRIPTION OF THE FIGURES

FIG. 1 is a micrograph of the molecular sieve powder used to coat the monolith in one embodiment of the present invention.

FIG. 2 is a micrograph of a thin section of the inside, together with portions of their exterior edges, of two molecular sieve crystals taken from the coating of a catalyst prepared by one of the methods presented herein but using a platinum reagent that does not chemisorb onto the exterior surface of molecular sieve crystals. This catalyst is typical of platinum-containing molecular sieve catalysts that have been suggested in the prior art for use in treating exhaust gas from an internal combustion engine.

FIG. 3 presents data comparing the performance (shown as NOₓ conversion) of a catalytic converter loaded with a catalyst having noble metal on the surface of molecular sieve crystals (but with no noble metal on alumina) against that of a typical catalytic converter using a typical catalyst when used to treat exhaust gas from the same lean-bum diesel engine.

FIG. 4 presents data comparing the performance (shown as NOₓ conversion) of three catalysts having noble metal on the surface of molecular sieve crystals (but with no noble metal on alumina) against that of a similar catalyst prepared without using the process taught by the present invention.

FIG. 5 presents data comparing the performance (shown as NOₓ conversion) of a catalytic converter loaded with a catalyst having noble metal on the surface of molecular sieve crystals (but with no noble metal on alumina) against that of a typical catalytic converter using a catalyst similar to that taught in Lachman '991 when used to treat exhaust gas from the same lean-bum diesel engine.

FIG. 6 presents data comparing the performance (shown as NOₓ conversion) of a catalyst of the present invention (using Y zeolite) wherein about 75% of the platinum is dispersed on the alumina against that of the same catalyst wherein an equivalent amount of platinum is dispersed entirely on the Y zeolite.

FIG. 7 presents data comparing the performance (shown as NOₓ conversion) of a catalyst of the present invention (using β zeolite) wherein about 75% of the platinum is dispersed on the alumina against that of the same catalyst wherein a higher amount of platinum is dispersed entirely on the β zeolite.

### DETAILED DESCRIPTION OF THE INVENTION

The catalytic converter of the present invention comprises a vessel and a catalyst contained in the vessel.

### Vessel

The exhaust gas processing vessel may be any suitable shape and configuration, with cylindrical or “flattened” cylindrical (i.e., an extended oval) being the preferred shapes, that provides a substantially uniform distribution of exhaust gas throughout and an efficient flow over the catalyst to be contained therein. The vessel should have sufficient void volume to contain a catalyst sized so that the gas hourly space velocity (“GHSV”) over the catalyst is no greater than about 150,000 hr⁻¹ when the engine producing the exhaust gas to be treated is operating at its maximum sustainable load. The vessel should be fitted at its inlet end with a tubular conduit adapted to receive exhaust from the engine exhaust manifold, and at its outlet end with a tubular conduit adapted to transmit treated exhaust to a muffler or directly to the atmosphere. Materials of construction of the vessel and inlet and outlet conduits are well known to those skilled in the art and may be of any metal or composite able to withstand temperatures of up to about 1200° C. with minimal corrosion from the compounds normally contained in internal combustion engine exhaust gas.

### Catalyst

The catalyst is comprised of a substrate on which has been suitably applied an effective amount of a catalytically active coating comprising at least one type of molecular sieve crystals, with platinum or a platinum alloy uniformly dispersed on the exterior surface of such crystals, and alumina with platinum or a platinum alloy dispersed thereon. The coating may also contain a binder and one or more types of molecular sieve crystals.

### Substrate

The substrate may be any of the shapes employed by those skilled in the art such as extrudates, spheres, beads, tablets, and the like, but monoliths, either metallic or ceramic, are preferred. The substrate should be inert in the sense that it does not react with the coating or with the exhaust gas to which it is exposed during engine operation.

If a monolith is employed as the substrate, it should be sized and shaped so that it fits within the vessel and leaves no gaps between the vessel interior wall and the outside surface of the monolith which might result in blow-by of the exhaust gas past the monolith (i.e., bypassing of the catalyst). Ceramic monoliths, if employed, should be provided with a mat-mount between the exterior surface of the monolith and the vessel wall, as is customary in the industry, to cushion vibration during engine operation and also to prevent blow-by of the engine exhaust gas past the catalyst. Metallic monoliths should be attached to the vessel wall, as is customary. There should be provided sufficient monolith to result in a GHSV as defined above in the discussion on Vessel.

### Coating

The catalyst coating for use in this invention is characterized as comprising molecular sieve crystals on the surface of which has been uniformly dispersed a catalytically effective amount of a noble metal, preferably platinum or a platinum alloy, and alumina impregnated with a catalytically effective amount of a noble metal, preferably platinum or a platinum alloy. The molecular sieve crystals on which the noble metal has been dispersed have diameters within a range of about 0.5 to about 50 μm. The portion of the noble metal that is dispersed on the surface of the molecular sieve crystals is done so in such a manner as to locate at least 90% of the noble metal within 50 nm (500 Å) of the exterior surface of the crystals. The alumina particles upon which the remainder of the noble metal is dispersed are also small, preferably about 5 μm in size. It is important that the alumina and molecular sieve crystals be thoroughly mixed so that both are uniformly dispersed throughout the coating.

The coating should be uniformly applied to the substrate. The coating's thickness should be no more than about 200 microns and no less than about 1 micron, with a coating thickness averaging between about 20 microns and 40 microns being preferred. Any method known to those skilled in the art including, without limitation, immersion of the substrate in an aqueous suspension of the desired coating or spraying of the suspension onto the substrate, may be employed to achieve the desired coating thickness and uniformity of application. The preferred method of application onto monoliths is “piston coating”, which involves placing the monolith above a reservoir containing an amount of the coating, compressing the coating up into the monolith with a piston, withdrawing the piston to permit the coating to drain back into the reservoir, and then immediately clearing the channels of the monolith with a slotted knife that emits compressed air. This method is particularly useful when applying coatings containing large mass fractions of molecular sieves since the sieve density is quite low.

Following application of the coating to the substrate, the coated substrate is dried and then calcined at a temperature of between about 400 and about 550° C. for 2 to 4 hours.

### Molecular Sieve

For the molecular sieve component of the catalytic coating of the present invention, only a single type of molecular sieve crystal is necessary. Any type of molecular sieve having an average pore size between about 0.4 nm (4 Å) and about 1 nm (10 Å) may be used, with the preferred type being Beta zeolite. The size of the crystals, regardless of the type chosen, should be between 0.5 and 50 microns, however, and a crystal size between about 1 and about 2 microns is preferred. If noble metal is to be deposited by covalent chemisorption, the silica/alumina ratio should be between about 10 and about 100,000, preferably between about 10 and about 100. If noble metal is to be deposited by ionic chemisorption, the silica/alumina ratio should be between about 20 and about 100,000, preferably between about 20 and about 100.

If the method to be used for noble metal deposition is covalent chemisorption, the molecular sieve should be modified to establish a thin alumina film on its exterior surfaces, either by steaming to mildly de-aluminate sieve crystals having a low Si/Al ratio or by treatment with an aqueous solution of very small pseudo-boehmite crystallites for sieves with a high Si/Al ratio. Optionally, the sieve crystals may be treated to expose acid sites on the crystal surface.

Some applications, however, such as those in which it is desirable to adsorb hydrocarbon during cold start of an engine, might benefit from incorporation into the coating a second, or even a third, type of sieve having characteristics desirable to that application. For instance, in a catalytic converter is intended for treatment of diesel exhaust, it might be desirable to employ two types of sieve, one with an average pore size less than 6 Å on which platinum or a platinum alloy has been dispersed and another (with an average pore size greater than 0.6 nm) which is capable of adsorbing the large hydrocarbon molecules present in the exhaust gas from such diesel engines. This larger-pore sieve would not necessarily require platinum or a platinum alloy dispersed thereon since conversion of hydrocarbon, carbon monoxide, and nitrogen oxides would be catalyzed primarily by the smaller-pore sieve.

### Alumina

The alumina particles of the catalytic coating of the present invention may be of any of the various phases of alumina, with the theta phase being preferred.

Alumina particles of suitable size may readily be made by methods known to those skilled in the art, with the preferred method being wet milling. Although alumina particles of mean diameter between about 1 μm and about 15 μm are acceptable, particles having a mean diameter of about 5 μm are preferred. However, the normal addition of acid that partially peptizes the alumina should be avoided.

The relative proportions of finely divided zeolite crystals and alumina particles may vary widely with the zeolite content ranging from about 10 to about 90 weight percent, and more usually in the range of about 10 to about 50 weight percent of the composite.

### Noble Metal

Platinum used alone is the preferred noble metal for use in this invention. In addition, however, platinum alloyed with rhodium, iridium, palladium, silver, or gold may be employed as the noble metal. The finished coating should contain between about 30 g/m³ and about 7000 g/m³ of noble metal divided between the alumina particles and molecular sieve crystals. Of the total amount of noble metal dispersed in the finished coating, about 10 wt. % to about 80 wt. %, preferably about 20 wt. % to about 40 wt. %, should be dispersed on the molecular sieve crystals, with the balance of the noble metal dispersed on the alumina particles contained in the coating.

### Preparation of Catalyst

The first step in the preparation of catalyst of the present invention is the preparation of an aqueous suspension of alumina particles and noble metal reagent. Prior to preparing the suspension, the alumina should be milled until its mean particle diameter is reduced to the desired size, preferably about 5 μm. An aqueous suspension comprising the milled alumina and the desired amount of noble metal reagent, without the normal addition of acid that partially peptizes the alumina, is then formed and stirred for sufficient time to disperse the reagent evenly on the alumina particles, usually about two hours. This alumina suspension is then later combined with an aqueous suspension comprising molecular sieve crystals and a noble metal reagent that will chemisorb onto the exterior 50 nm (500 Å), as follows.

The key element of the present invention is that the portion of platinum or the platinum alloy to be dispersed on the molecular sieve crystals be dispersed predominantly on the exterior surface of the zeolite crystals chosen for the particular application, and preferably so that a very high proportion, above 90 %, of the platinum or the platinum alloy is sited within 50 nm (500 Å) of the exterior crystal surfaces. It has been discovered that there are a number of methods of dispersing platinum or a platinum alloy on zeolite in a suitable manner. These methods involve contacting a solution of a soluble compound or a suspension of colloidal platinum or platinum alloy with the zeolite crystals on which the platinum or a platinum alloy is to be dispersed in the absence of any other type of zeolite crystals or any inorganic oxide binder which is or are to be included in the catalyst.

One such method employs, as the depositing agent for platinum, compounds that will chemisorb predominantly on and near the exterior surface of the zeolite crystals by forming either a covalent or an ionic bond between the noble metal and the zeolite. This method is particularly preferred. Compounds that form a covalent bond include Pt sulfite, [N(C₂H₅)₄]₂ [Pt(OH)₆], and Pt ethanolamine, with Pt sulfite being preferred; compounds that form an ionic bond include [Pt(NH₂CH₂CH₂NH₂)₂][OH]₂ and [Pt(NH₂CH₂CH₂NH₂)₂][CO₃]. The Pt sulfite employed in this invention should be a non-cationic square-planner Pt complex in which each Pt has two Pt—S bonds and whose charge is believed to be between −4 and zero, depending on pH.

Another method involves pretreatment of the zeolite crystals on which platinum or a platinum alloy is to be dispersed with a sufficient amount of hydrophilic polymer prior to exposure of the crystals to a platinum or a platinum alloy salt suspended in water. The hydrophilic polymer should be applied so as to fill up or block a sufficient number of the zeolite pores to intrusion of platinum species or a platinum alloy colloid into the crystal interior. The hydrophilic polymer will be subsequently removed completely from the catalyst during calcining of the finished catalyst. Some hydrophilic polymers suitable for this purpose include polyethylene glycol, polyvinyl glycol and polyvinyl pyrollidone, with polyethylene glycol being particularly preferred.

A third method employs, as the depositing agent for platinum or a platinum alloy, metallic colloidal particles of platinum or a platinum alloy of a size substantially greater, by at least a factor of two, than the largest crystallographically defined pore diameter of the molecular sieve crystals onto which the noble metal is to be deposited.

A fourth method, involving placing a noble metal precursor into the reactor during the production or synthesis of a zeolite, is taught in U.S. Pat. No. 5,290,534 (Tsao).

### Preparation Using Pt Reagents that Chemisorb onto Zeolite Crystal Exterior Surface

In this preferred method of preparation, an amount of platinum or a platinum alloy reagent capable of being chemisorbed onto the exterior of molecular sieve crystals is mixed with an aqueous suspension of the type and size of molecular sieve crystals to be employed in the catalyst.

If the reagent chosen forms a covalent bond with the zeolite, it is important that the molecular sieve crystals used in this process be modified to have a very thin film of aluminum oxide on their exterior surfaces. The choice of method for forming this thin alumina film depends on the Si/Al ratio of the zeolitic precursor. For molecular sieves that have Si/Al ratios less than about 12 such as Zeolite Y, the requisite alumina film can be established by de-aluminating the zeolitic precursor to some degree by exposure to steam. For molecular sieves with Si/Al ratios greater than about 12 such as MFI-38 that do not have sufficient constituent aluminum to permit formation by de-alumination of a useful alumina film while retaining high acid site concentration, the requisite alumina film can be established by treating the zeolitic precursor with an aqueous solution of very small crystallite boehmite. The boehmite crystallites used to promote formation of this thin alumina film should be less than about 4 nm in size, with crystallites of between 2.5 nm and 3.5 nm being preferred. The solution employed should be such that significant aggregation of the crystals has not occurred. Sols that are essentially colorless and transparent but nevertheless contain alumina equivalent to over 5 wt. % alumina have not had significant agglomeration of the boehmite crystallites. The use of this procedure results in the exterior surfaces of the zeolite being derivatized, with a thin (approx. 3 to 5 nm) alumina film deposited thereon.

If the reagent chosen forms an ionic bond with the zeolite, it is important that the zeolite chosen have a Si/Al ratio above about 20 and that the pH of the aqueous suspension of zeolite be above 10, prior to the addition of the noble metal compound, to deprotonate the siliceous exterior surface of the zeolite.

The amount of noble metal reagent added should be determined by the noble metal loading desired in the catalyst to be prepared. The range of noble metal loadings should be between 0.05 % and 10%of sieve weight, with the preferred range being between about 1 and about 3 weight % of sieve weight.

If the reagent chosen forms a covalent bond with the zeolite, sufficient base is then added to the suspension to adjust its pH to between about 7 and 8. The base employed should be one that will decompose to yield gaseous products when its temperature is raised above about 150° C., and the preferred base is tetramethylammonium hydroxide. If the reagent chosen forms an ionic bond with the zeolite, no further pH adjustment is required because the aqueous suspension of zeolite should already be at a pH above 10. The suspension is then stirred long enough to allow the noble metal reagent to be chemisorbed onto the molecular sieve crystals, a period of at least one hour.

If another type of molecular sieve crystals is to be included in the catalyst being prepared, an aqueous suspension of this second type of molecular sieve is then added to the suspension already prepared. Along with this second type of molecular sieve, the aqueous suspension of alumina impregnated with noble metal prepared above should then be added to the mixture already prepared. The entire mixture is then stirred for a period of time sufficient to thoroughly mix the compounds that have been included in the suspension.

The suspension as prepared is then applied to a substrate, preferably a monolith, by any of the methods known to those skilled in the art, and preferably by piston coating, to achieve the desired thickness of coating disposed on the substrate. It is then dried and calcined by any of a number of methods known to those skilled in the art.

### Preparation Using Hydrophilic Polymer

In this method of catalyst preparation, a hydrophilic polymer is employed to fill the pores of the molecular sieve crystals prior to application of platinum or a platinum alloy to the crystals, thereby preventing the platinum or a platinum alloy from being deposited other than on the surface of the crystals.

Suitable hydrophilic polymers will be any such polymer having a density of between about 0.8 and 1.0 gm./cm.³ and that completely volatilizes at calcining temperatures. Preferred polymers for this application include, without limitation, polyethylene glycol, polyvinyl glycol and polyvinyl pyrollidone. Polyethylene glycol is particularly preferred.

In this method of catalyst preparation then, an amount of hydrophilic polymer sufficient to fill the pores of the molecular sieve crystals, without overfilling thereby leaving polymer on the surface of the crystals, is added to an aqueous suspension of the molecular sieve to be used, and the suspension is stirred for a period of at least 30 minutes to promote adsorption of the polymer in the pores of the crystals. A suitable method for determining the amount of polymer to apply is:

1) the pore volume per unit mass of the molecular sieve to be employed is measured;

2) a concentrated solution of a hydrophilic polymer is prepared and the density of the solution is determined;

3) the quantity of the hydrophilic polymer solution to be added to the molecular sieve is set so that the product of the mass of the sieve to be treated times the sieve's pore volume per unit mass of sieve times the density of the hydrophilic polymer solution divided by the mass of polymer solution is between 1 and 0.25.

Following adsorption of the polymer into the crystal pores, a quantity of de-ionized water may be added to the solution to yield an appropriate coating precursor.

Any platinum or a platinum alloy reagent known to those skilled in the art is then added to the suspension in an amount determined to provide the desired platinum or platinum alloy loading on the final catalyst, in a similar manner to the method described above. The remainder of this procedure is the same as for the procedure above using those platinum or platinum-alloy reagents that chemisorb preferentially on the surface of the molecular sieve crystals.

### Preparation Using Colloidal Particles of Noble Metal

This method of preparation is superficially similar to the method described above using Pt reagents that chemisorb onto the exterior surface of molecular sieve crystals, although the nature of the chemical interactions resulting in deposition of the colloidal metal onto the zeolite is believed to be different.

An aqueous suspension of colloidal particles of platinum or a platinum alloy is added to an aqueous suspension of molecular sieve crystals. It is necessary that the size of the colloidal particles be at least twice the largest crystallographically-defined pore diameter of the molecular sieve crystals so that the colloidal particles cannot enter the crystal pores, and are therefore adsorbed on the surface of the crystals. The pH may optionally be adjusted to promote chemisorption of the colloidal metal onto the molecular sieve. The remainder of this procedure is the same as for the procedure above using those platinum or platinum-alloy reagents that chemisorb preferentially on the surface of the molecular sieve crystals.

### EXAMPLE 1

This example describes the preparation of a catalyst comprising Y molecular sieve on the exterior surface of which Pt is covalently chemisorbed.

An aqueous suspension of ultra-stable Y molecular sieve that had been partially de-aluminated by exposure to steam was prepared and sufficient Pt sulfite was added to yield molecular sieve crystals having about 2 wt. % Pt on sieve. Sufficient tetramethylammonium hydroxide was added to raise the pH to about 7 and the suspension was then stirred for several hours to permit chemisorption reactions between the Pt sulfite and the molecular sieve crystals to occur. Then a milled suspension of Condea SCFA-90, consisting predominately of θ-alumina, was added without the normal addition of acid that partially peptizes the alumina. The mixture was then stirred for several hours, dried and calcined.

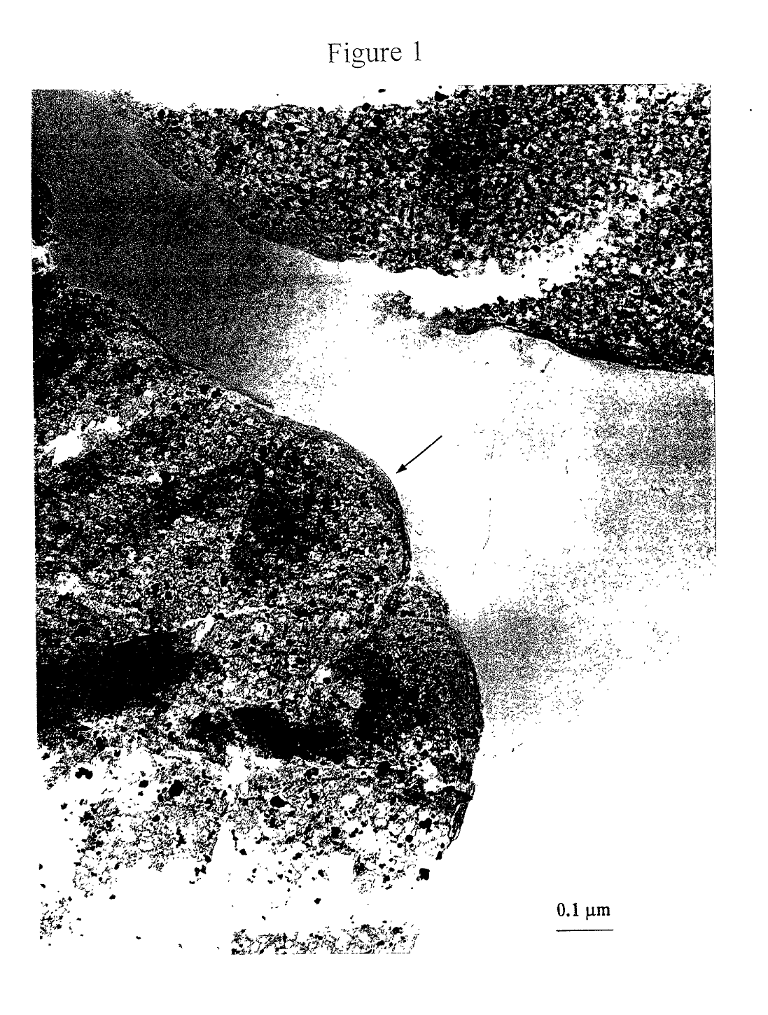

A sample of this material was analyzed by cutting thin sections of particles contained in the sample. FIG. 1 is a micrograph of these particles. It is clear from this figure that Pt is not found throughout the bulk of the molecular sieve crystals; rather, Pt does occur at the exterior surface of the molecular sieve crystals, appearing as dark particles.

### EXAMPLE 2

### Comparative

This example describes the preparation of a catalyst that has been suggested in the prior art for use in treating exhaust gas from an internal combustion engine.

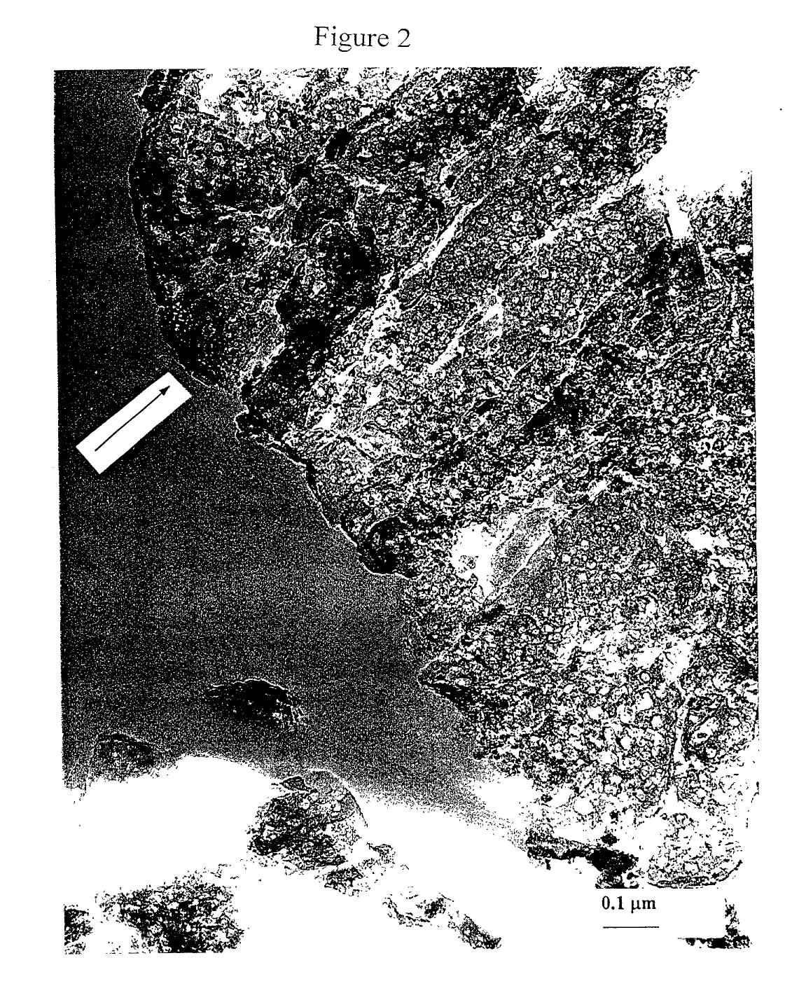

A catalyst sample was prepared using the same method as employed in Example 1, except that [Pt(NH₃)₄][OH]₂ was used as the platinum reagent instead of Pt sulfite. Again, a sample of this material was analyzed by cutting thin sections of particles contained in the sample. FIG. 2 is a micrograph of these particles. In this figure is shown dark particles through the bulk of the sieve crystals. An arrow points to a film on the surface of the crystal. It should be noted that no platinum is present on this film; rather, the platinum is present in regions away from the edges. The possibility that those platinum particles are at the exterior surface can be dismissed since, in the regions where platinum is seen, the exterior surface has been cut away.

### EXAMPLE 3

### Comparative

This example compares the performance (as measured by NOₓ conversion) of the catalyst prepared by the process described in Example 1 against that of the system prepared in Example 2.

Catalytic converters were manufactured using the suspensions prepared in Examples 1 and 2 applied to equivalent size and type monoliths followed by drying and calcining. One converter at a time was connected to the exhaust pipe of a Peugeot IDI, turbocharged U60 engine. Catalyst inlet temperature was varied at constant speed (1540 rpm) by variation of the load placed on the engine, i.e., as load increased, inlet temperature increased. Diesel fuel was injected into the exhaust gas between the engine outlet and the converter inlet to adjust the hydrocarbon/NOₓ ratio to 10 at each load set point. NOₓ concentrations were determined using a chemiluminescent NOₓ analyzer.

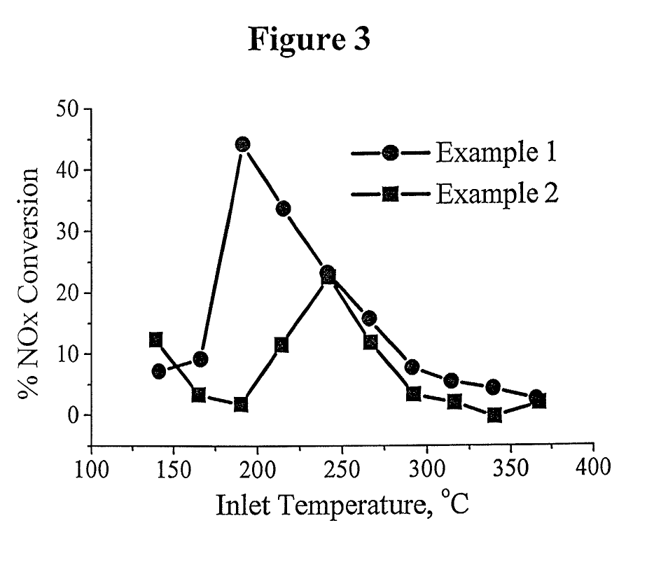

The results of this test are shown in FIG. 3. NOₓ conversion versus converter inlet temperature is plotted for each of the converters, with the performance of the converter using the catalyst prepared as in Example 1 shown as solid circles, ●, and that of the converter using the system prepared as in Example 2 as solid squares, ▪. It is clear that the converter of Example 1 demonstrates far superior NOₓ conversion compared to the converter using a typical catalyst formulation. NOₓ conversion begins at a lower temperature , reaches a higher maximum, and continues at a higher level over the entire temperature range of interest.

### EXAMPLE 4

This example describes preparation of catalysts comprising MFI molecular sieve on the exterior surface of which Pt is is covalently chemisorbed. It illustrates a variant of the method described in Example 1 that is useful where the zeolite employed has a high Si/Al ratio.

Three suspensions, each containing 20 grams of a molecular sieve with the MFI structure and a Si/Al ratio of 19 in 100 grams of de-ionized water, were prepared. Two grams of Condea Tondersol 10/2, a very fine, 10 wt. % dispersion of pseudo-boehmite in water, was added to the first suspension, 10.5 grams to the second and 22.2 grams to the third. Catalytic coating precursors containing 1 %, 5%and 10%added Al₁O₃, respectively, were produced. After stirring for 5 minutes, each mixture was quantitatively transferred to a steam evaporator and the water evaporated away over a period of three hours. The resulting solids were then separately calcined at 500° C. for 4 hours. Then, 10 gram samples of each of these solids were suspended in 50 grams of de-ionized water. To each suspension about 2 grams of a 9.94%Pt sulfite aqueous solution was added, making three suspensions differing only in alumina content. After stirring for one hour, each was filtered and the resultant solid calcined at 500° C. for 4 hours.

A fourth sample of catalyst was prepared according to the procedure described above, but without the addition of Condea Tondersol 10/2.

The chemical compositions of the resulting catalysts are shown in Table 1.

TABLE 1

| Designa- | MFI | MFI-1% Al₂O₃ | MFI-5% Al₂O₃ | MFI-10% Al₂O₃ |
|---|---|---|---|---|
| tion: | | | | |
| Added | None | 1% | 5% | 10% |
| Al₂O₃: | | | | |
| Al, %: | 2.458 | 2.982 | 4.352 | 7.493 |
| Si, %: | 42.233 | 42.646 | 41.931 | 38.737 |
| Pt, %: | 0.142 | 0.193 | 0.557 | 1.360 |

It should be noted that the platinum content of the samples increases in rough proportion to the added alumina. Since the alumina is size-excluded from the zeolite and therefore resides on exterior surfaces of the WFI crystals, the Pt is supported on alumina that is supported on the zeolite, in rough analogy to the Pt—Y material prepared in Example 1.

### EXAMPLE 5

The effectiveness for NOₓ reduction of the four catalysts prepared in Example 4 is compared in this example.

In turn, a 1 gram sample of each of the materials was loaded into a quartz reactor which was placed in a furnace and subjected to the following program. A gas consisting of 1000 ppm NOₓ, 300 ppm CO, 8% H₂O, 8% CO₂, 500 ppm octane (4000 ppm C₁), 20 ppm SO₂, 12% O₂, and the balance N₂ was passed over the sample at a flow rate of 5 liters per minute. The inlet temperature to the reactor was increased from about 50° C. to 550° C. at a rate of 7° C. per minute, then held constant for one hour, and finally cooled rapidly until the reactor temperature returned to 50° C. The heating, holding and cooling regimen was then repeated.

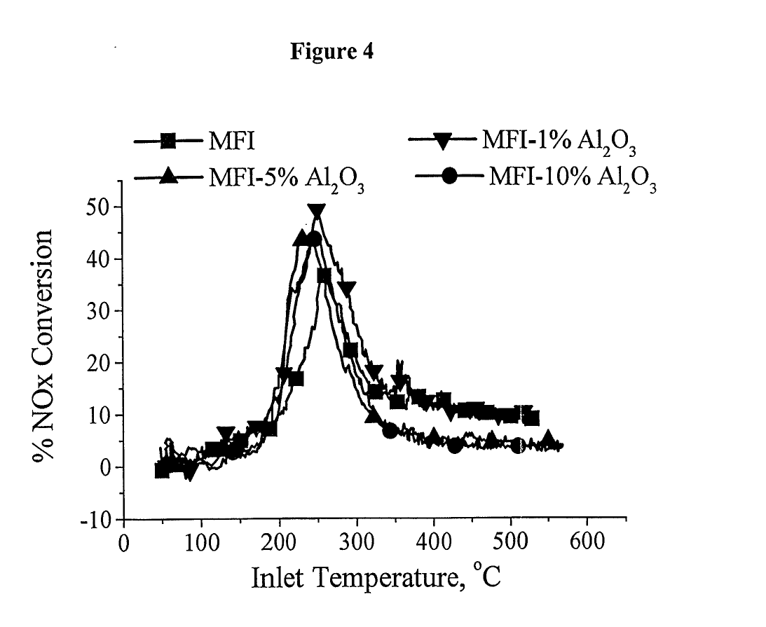

FIG. 4 shows NOₓ conversion as a function of catalyst inlet temperature during the first temperature ramp for each of the samples. The data obtained during the second ramp were essentially identical. The catalyst designated MFI, having no added alumina, shows modest performance. Maximum NOₓ conversion is about 36%. NOₓ conversion for the catalyst designated MFI-1%Al₂O₃ increases to 50 %, and the range of temperature over which significant conversion occurs, the “conversion window”, is considerably broader than for the MFI catalyst. The modest increase in Pt content (0.19%vs. 0.15 %) is quite effective at improving NOₓ conversion. This is as expected for platinum situated on the exterior surfaces of the molecular sieve. The additional alumina, and consequent increases in Pt chemisorption, associated with the other two samples produces modest incremental improvement.

### EXAMPLE 6

This and the following example describe preparation of catalysts comprising Beta zeolite using colloidal Pt particles to deposit Pt on the sieve exterior surface.

20 grams of NH₄-Beta zeolite were suspended in 200 grams of de-ionized water. To this suspension, 22.3 grams of a stable aqueous Pt colloid solution prepared by PGP Industries, Inc. that contains 1.83 wt. % of Pt colloid particles roughly 2 nm. in size were added. The suspension was then stirred for 2 hours and filtered. The filter cake was dried at 100° C. for about 60 hours. Analysis of a sample of the filter cake showed that the Pt content of fine powder was 1.29 %. Transmission Electron Microscopic (TEM) examination of thin sections of the catalyst revealed homogeneously distributed, apparently non-faceted Pt particles about 2 nm in size. Since the largest micro-pore opening in Beta is about 0.7 nm, it can be concluded that the Pt is on the exterior surface of the Beta. Relatively high concentration of Pt occurs apparently due to the disordered, mesoporous texture of Beta that results in a relatively high exterior surface area.

### EXAMPLE 7

A sample of catalyst was prepared using the same procedure as Example 6 except that the zeolite used was H-MFI. TEM examination revealed the same structure as the catalyst in Example 6, but the resulting catalyst had a Pt content of only 0.06 %. The lower Pt content is due to the nature of the MFI crystals which are about 1 micron in size with very little surface area available for metal deposition. Since very little surface area is available for physical adsorption, and apparently there is not a strong driving force for chemisorption with this procedure, only a small amount of Pt is deposited. Since the largest micro-pore opening in MFI is about 0.55 nm, it can be concluded that the Pt is on the exterior surface of the MFI.

### EXAMPLE 8

This example describes preparation of catalysts comprising molecular sieve using bulky Pt complexes to deposit Pt on the sieve exterior surface by ionic chemisorption.

A solution of bis(ethylenediamine)Pt(Hl) hydroxide containing 5.92 wt. % Pt was supplied by PGP. Three solutions were prepared, each containing 6.895 grams of the PGP solution diluted with 185 grams of de-ionized water. To each of the solutions 20 grams of a molecular sieve with the MFI structure and a Si/Al ratio of 19 were added. The pH of the resulting solutions was about 6. Tetraethylammonium hydroxide was added to the solutions to raise the pH of one sample to 8.5, another to 9.0 and the third to 11.0. The solutions were stirred overnight, then filtered and calcined in air for 4 hours at 400° C.

Samples of fine powder from each catalyst were embedded in epoxy, thin-sectioned and examined by TEM, which revealed Pt particles from 10 to 50 nm. The particles decreased in size with increasing pH of the synthesizing solution, which is consistent with generation of the largest number of adsorption sites on the siliceous surface of MFI at highest pH. As in Example 7, due to the large size of the Pt complex relative to the zeolite pore size, it can be concluded that the Pt is on the exterior surface of the MFI.

### EXAMPLE 9

### Comparative

An aqueous suspension of Condea SCFA-90 alumina was mixed with Pt sulfite for a period of time sufficient to result in chemisorption of the platinum. The suspension was then mixed with ultra-stable Y molecular sieve that had been partially dealuminated by exposure to steam. However, since the Pt had already chemisorbed onto the alumina, essentially no Pt was deposited onto the zeolite. The mixture was wash-coated onto a monolithic substrate and then manufactured into a catalytic converter. This procedure is the preferred procedure taught by Lachman '991. The volumetric concentrations of Pt, alumina, and molecular sieve were about the same as in the catalyst of Example 1.

The performance of this catalytic converter was then compared to that of the converter of Example 3 made from the suspension of Example 1. One converter at a time was connected to the exhaust pipe of a Peugeot IDI, turbocharged U60 engine. Catalyst inlet temperature was varied at constant speed (1540 rpm) by variation of the load placed on the engine, i.e., as load increased, inlet temperature increased. Diesel fuel was injected into the exhaust gas between the engine outlet and the converter inlet to adjust the hydrocarbon/NOₓ ratio to 10 at each load set point. NOₓ concentrations were determined using a chemiluminescent NOₓ analyzer.

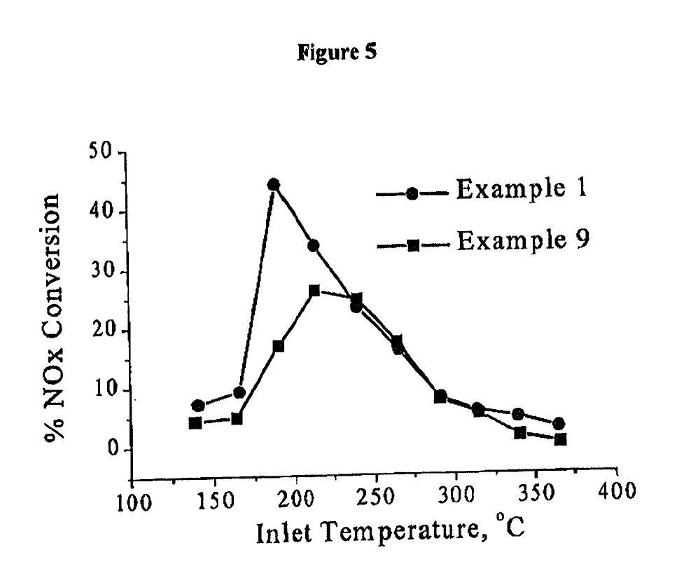

The results of this test are shown in FIG. 5. NOₓ conversion versus converter inlet temperature is plotted for each of the converters, with the performance of the converter using the catalyst prepared as in Example 3 (using the suspension of Example 1) shown as solid circles, ●, and that of the converter using the system prepared as in this Example 9 as solid squares, ▪. It is clear that the converter having its noble metal dispersed on the exterior surface of molecular sieve demonstrates far superior NOₓ conversion compared to the converter using a catalyst formulation similar to that taught by Lachman.

### EXAMPLE 10

### Comparative

This example describes the preparation of a catalyst comprising Y molecular sieve, on the exterior surface of which Pt is covalently chemisorbed, used in performance comparison against a catalyst of the present invention prepared in Example 11.

An aqueous suspension of ultra-stable Y molecular sieve that had been partially de-aluminated by exposure to steam was prepared and sufficient Pt sulfite was added to yield a finished catalytic coating having about 0.00247 g/cm³ (70 g/ft³) Pt. Sufficient tetramethylammonium hydroxide was added to raise the pH to about 7 and the suspension was then stirred for two hours to permit chemisorption reactions between the Pt sulfite and the molecular sieve crystals to occur. Then a milled suspension of Condea SCFA-90, consisting predominately of θ-alumina, was added without the normal addition of acid that partially peptizes the alumina. The mixture was then stirred for several hours, wash coated onto a 400 cell cordierite monolith, dried and calcined. The resultant coating contained about 0.122 g/cm³ (2 g/in³) of the ultrastable Y zeolite, about 0.0183 g/cm³ (0.3 as g/in³) of the SCFA-90 alumina and about 0.00247 g/cm³ (70 g/ft³) Pt.

### EXAMPLE 11

This example describes the preparation of a catalyst of the present invention using Y zeolite.

An aqueous suspension of ultra-stable Y molecular sieve that had been partially de-aluminated by exposure to steam was prepared and one-quarter of the amount of Pt sulfite used in Example 10 was added. Sufficient tetramethylammonium hydroxide was added to raise the pH to about 7 and the suspension was then stirred for several hours to permit chemisorption reactions between the Pt sulfite and the molecular sieve crystals to occur.

An amount of Condea SCFA-90 alumina was wet milled until the mean particle size of the alumina was about 5 μm. Another aqueous suspension consisting of the milled alumina was prepared and three-quarters of the amount of Pt sulfite used in Example 10 was added. The suspension was then stirred for two hours, then combined with the sieve suspension and thoroughly mixed. It was then wash coated onto a 400 cell cordierite monolith, dried and calcined. The resultant coating contained about 0.122 g/cm³ (2 g/in³) of the ultrastable Y zeolite, about 0.0183 g/cm³ (0.3 g/in³) of the SCFA-90 alumina and about 0.00247 g/cm³ (70 g/ft³) Pt.

### EXAMPLE 12

### Comparative

This example compares the NOₓ reduction effectiveness of the catalysts prepared in Examples 10 and 11.

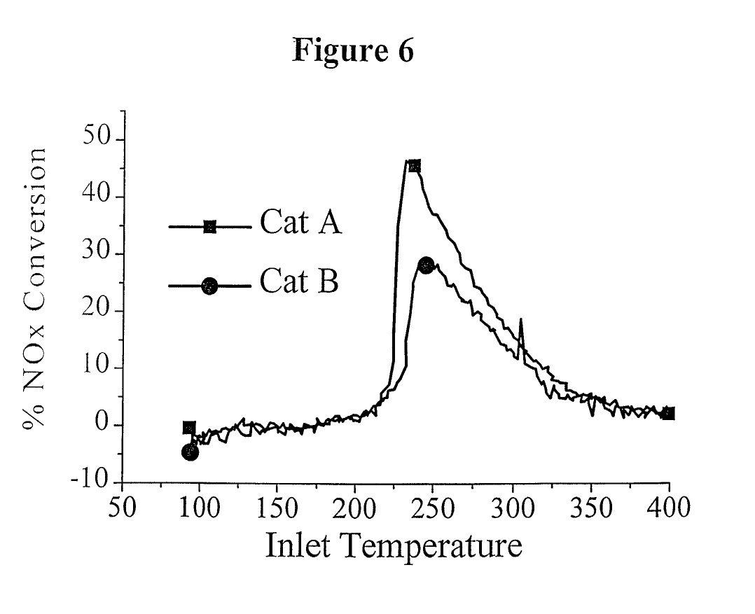

The NOₓ reduction effectiveness of a small cylindrical sample (2.032 cm [0.8 inch] long and 2.2225 cm [⅞ inch] diameter) taken from the monolith of the catalyst prepared in Example 11 (designated Catalyst “A” on FIG. 6) was compared to that one taken from the catalyst prepared in Example 10 (designated Catalyst “B” on FIG. 6) using a synthetic gas bench. A gas consisting of 1000 vppm NOₓ, 500 vppm n-octane (4000 ppm C₁), 300 vppm CO, 20 vppm SO₂, 8 vol. % H₂O, 8 vol. % CO₂, and the balance N₂ was passed through the samples at a space velocity of 38,000 hr⁻¹ and NOₓ conversion was measured as a function of temperature. The data are shown in FIG. 6. The catalyst of the present invention (Catalyst “A”) is more effective, showing a maximum NOₓ conversion of 48%at 232° C. versus a maximum NOₓ conversion for the comparative catalyst (Catalyst “B”) of about 29%at 242° C. Catalyst A exhibits higher NOₓ conversion than does Catalyst B throughout the entire temperature range where either is active for catalyzing NOₓ conversion.

### EXAMPLE 13

### Comparative

This example describes the preparation of a catalyst comprising Beta zeolite, on the exterior surface of which Pt is covalently chemisorbed, used in performance comparison against a catalyst of the present invention prepared in Example 14.

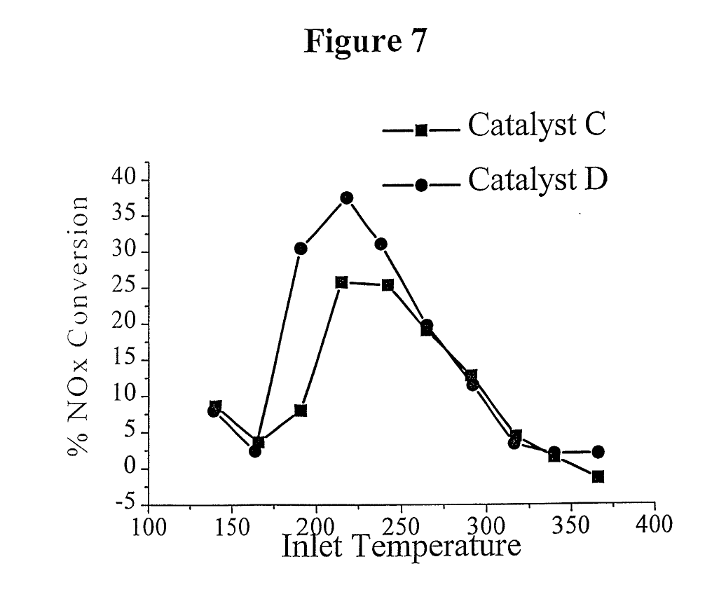

A catalyst (designated Catalyst “C” in FIG. 7) was prepared as in Example 10 except that Beta zeolite was substituted for Y molecular sieve and an amount of platinum sulfite yielding a finished catalyst containing 0.00226 g/cm³ (64 g/ft³) Pt was used. The Beta zeolite had a Si/Al ratio of about 20 and organic template remained within the zeolite even though alkali metal cations initially present in the zeolite had been exchanged with protons.

### EXAMPLE 14

This example describes the preparation of a catalyst of the present invention using Beta zeolite.

A catalyst (designated Catalyst “D” in FIG. 7) was prepared as in Example 11 except that Beta zeolite was substituted for Y molecular sieve and the finished catalyst contained 0.061 g/cm³ (1 g/in³) of the Beta zeolite, 0.079 g/cm³ (1.3 g/in³) of the SCFA-90 alumina and about 0.00177 g/cm³ (50 g/ft³) Pt.

### EXAMPLE 15

### Comparative

This example compares the NOₓ reduction effectiveness of the catalysts prepared in Examples 13 and 14.

Catalytic converters containing 2.5 liters of the catalysts made in Examples 13 and 14 were evaluated for NOₓ conversion under the same test conditions as specified in Example 3. As shown on FIG. 7, the catalyst of the present invention (Catalyst “D”) began reducing NOₓ at a lower temperature than did the comparative catalyst (Catalyst “C”), in spite of the fact that catalyst “C” has about 25% more platinum. Over the range of temperatures where the two catalysts reduce NOₓ catalyst “D” is at least as good or better than Catalyst “C”.

We claim:

1. A catalytic converter for treating exhaust gas from an internal combustion engine, comprising: an exhaust gas processing vessel of suitable size and shape, adapted to receive exhaust directly from the engine; and an effective amount, contained in said vessel, of a catalyst coating uniformly dispersed on a substrate adapted to fit within said vessel, said coating comprising:
at least one type of molecular sieve crystals having diameters within a range of 0.5 μm. to 50 μm., said crystals having a catalytically effective amount of noble metal dispersed thereon in a manner such that at least 90% of the noble metal on said crystals is located within 500 Å of the exterior surface of said crystals, and
alumina particles between about 1 μm. and about 15 μm. in diameter having a catalytically effective amount of noble metal dispersed thereon.

2. The catalytic converter of claim 1 wherein said crystals and alumina particles are evenly dispersed throughout said coating and said coating is between 1 μm. and 200 μm. thick.

3. The catalytic converter of claim 1 wherein the substrate is a monolith.

4. The catalytic converter of claim 1 wherein the noble metal is selected from the group consisting of Pt and Pt alloyed with Rh, Ir, Pd, Ag, or Au.

5. The catalytic converter of claim 1 wherein only one type of molecular sieve crystals is employed.

6. The catalytic converter of claim 1 wherein said coating comprises:
between about 10 wt. % and about 90 wt. % of said molecular sieve crystals;
between about 10 wt. % and about 90 wt. % of said alumina particles; and
wherein the amount of said noble metal on said molecular sieve crystals is between about 10%and about 80%of the amount of said metal in said coating.

7. A catalyst for treating exhaust gas from internal combustion engines, comprising a catalyst coating uniformly dispersed on a substrate, said coating comprising:
at least one type of molecular sieve crystals having diameters within a range of 0.5 μm. to 50 μm., said crystals having a catalytically effective amount of noble metal dispersed thereon in a manner such that at least 90%of the noble metal is located within 500 Å of the exterior surface of said crystals, and alumina particles between about 1 μm. and about 15 μm. in diameter having a catalytically effective amount of noble metal dispersed thereon.

8. A process for making a catalyst containing alumina particles impregnated with noble metal and at least one type of molecular sieve crystals having noble metal predominantly on the exterior surface of said molecular sieve crystals, comprising:
a) preparing an aqueous suspension of at least one type of molecular sieve crystals and a noble metal reagent, said reagent being of the type that, when suspended in water, will chemisorb onto the exterior 500 Å of said crystals by forming a covalent bond between said reagent and said crystals, said crystals having been subjected to pre-treatment to establish an alumina film on their exterior surfaces;
b) adding sufficient base to the suspension to raise its pH to above about 7, said base being of a type that will decompose to yield gaseous products when its temperature is raised above about 150° C.;
c) stirring for at least one hour;
d) optionally adding an aqueous suspension of at least one type of molecular sieve crystals different from the type employed in step (a) to the product of step (c);
e) stirring the product of step (d) for at least one hour;
f) milling alumina particles, thereby reducing said particles' mean diameter to between about 1 μm. and about 15 μm.;
g) preparing an aqueous suspension of said alumina particles and a noble metal reagent;
h) stirring the product of step (g) for at least one hour and then mixing it with the product of step (e);
i) coating a substrate with the product of step (h) thereby preparing a coated substrate;
and
j) drying and calcining said coated substrate.

9. A process for making a catalyst containing alumina particles impregnated with noble metal and at least one type of molecular sieve crystals having noble metal predominantly on the exterior surface of said molecular sieve crystals, comprising:
a) preparing an aqueous suspension of at least one type of molecular sieve crystals, said suspension having a pH above 10, and a noble metal reagent, said reagent being of the type that, when suspended in water, will chemisorb onto the exterior 500 Å of said crystals by forming an ionic bond between said reagent and said crystals;
b) stirring for at least one hour;
c) optionally adding an aqueous suspension of at least one type of molecular sieve crystals different from the type employed in step (a) to the product of step (b);
d) stirring the product of step (c) for at least one hour;
e) milling alumina particles, thereby reducing said particles' mean diameter to between about 1 μm. and about 15 μm.;
f) preparing an aqueous suspension of said alumina particles and a noble metal reagent;
g) stirring the product of step (f) for at least one hour and then mixing it with the product of step (d);
h) coating a substrate with the product of step (g) thereby preparing a coated substrate; and
i) drying and calcining said coated substrate.

10. A process for making a catalyst containing alumina particles impregnated with noble metal and at least one type of molecular sieve crystals having noble metal predominantly on the exterior surface of said molecular sieve crystals, comprising:
a) preparing an aqueous suspension of at least one type of molecular sieve crystals and an amount of a hydrophilic polymer having a density of between about 0.8 and about 1.0 gm/cm³, said amount of hydrophilic polymer being sufficient to fill the pores of said molecular sieve crystals;
b) adding a noble metal reagent to the product of step (a);
c) adding sufficient base to the suspension to raise its pH to above about 7, said base being of a type that will decompose to yield gaseous products when its temperature is raised above about 150° C.;
d) stirring for at least one hour;
e) optionally adding an aqueous suspension of at least one type of molecular sieve crystals different from the type employed in step (a) to the product of step (d);
f) stirring the product of step (e) for at least one hour;
g) milling alumina particles, thereby reducing said particles' mean diameter to between about 1 μm. and about 15 μm.;
h) preparing an aqueous suspension of said alumina particles and a noble metal reagent;
i) stirring the product of step (h) for at least one hour and then mixing it with the product of step (f);
j) coating a substrate with the product of step (i) thereby preparing a coated substrate; and
k) drying and calcining said coated substrate.

11. A process for making a catalyst containing alumina particles impregnated with noble metal and at least one type of molecular sieve crystals having noble metal predominantly on the exterior surface of said molecular sieve crystals, comprising:
a) preparing an aqueous suspension of at least one type of molecular sieve crystals and colloidal particles of noble metal, the size of said noble metal particles being at least twice the largest crystallographically-defined pore diameter of the molecular sieve crystals;
b) adjusting the suspension pH to between about 7 and about 8.;
c) stirring for at least one hour;
d) optionally adding an aqueous suspension of at least one type of molecular sieve crystals different from the type employed in step (a) to the product of step (c);
e) stirring the product of step (d) for at least one hour;
f) milling alumina particles, thereby reducing said particles' mean diameter to between about 1 μm. and about 15 μm.;
g) preparing an aqueous suspension of said alumina particles and a noble metal reagent;
h) stirring the product of step (g) for at least one hour and then mixing it with the product of step (e);
i) coating a substrate with the product of step (h) thereby preparing a coated substrate; and
j) drying and calcining said coated substrate.

12. A method for treating exhaust gas from a motor vehicle diesel engine to reduce the amounts of hydrocarbon, carbon monoxide and NOₓ emitted to the atmosphere which comprises passing the exhaust gas through the catalytic converter of claim 1.

13. A method for treating exhaust gas from a motor vehicle diesel engine to reduce the amounts of hydrocarbon, carbon monoxide and NOₓ emitted to the atmosphere comprising passing the exhaust gas through a converter containing the catalyst made by the process of claim 8, 9, 10, or 11.
